(19) United States
(12) Patent Application Publication
(10) Pub. No.: US 2010/0172079 A1
(43) Pub. Date: Jul. 8, 2010

(54) DISPLAY CONTROL DEVICE AND COMPUTER HOST HAVING THE SAME

(75) Inventors: CHAO-CHUNG WU, Taipei (TW); KUO-CHOU CHIU, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTeK COMPUTER INC., Taipei (TW)

(21) Appl. No.: 12/652,189

(22) Filed: Jan. 5, 2010

(30) Foreign Application Priority Data
Jan. 7, 2009 (TW) 098100422

(51) Int. Cl. G06F 1/16; E05C 19/00

(52) U.S. Cl. 361/679.21; 292/1

(57) ABSTRACT

A display control device and a computer host having the display control device are disclosed. The display control device is disposed in a host case of the computer host, and it includes a body including a control circuit electronically connected to the computer host, a control panel electrically connected to the control circuit, and a pivot unit connected to the body and the control panel to change the surface of the control panel between a close state and an open state relative to the host case. In addition, the computer host is controlled via an operating unit on the control panel.

### FIELD OF THE INVENTION

The invention relates to a display control device and, more particularly, to a display control device whose control panel may be adjusted and a computer host having a display control device.

### BACKGROUND OF THE INVENTION

FIG. 1A is a schematic diagram showing a conventional host 1 of a desktop computer. Generally, a host panel 10 of a computer usually has at least a power on button 101, a connecting interface slot 102, peripheral device slots 103a and 103b and an indicating light 104. The power on button 101 allows the user to control the power source of the computer host, and the indicating light 104 may show a power state of the host and the action of a disk drive. The connecting interface slot 102 such as a universal serial bus (USB) slot may allow an external element (such as a printer or a mouse) to connect and thus allow the external element to exchange data with the computer host 1. In addition, various peripheral devices such as a compact disk drive, the disk drive or the display control device may be inserted in the peripheral device slots 103a and 103b.

Basically, to insert the peripheral devices in the peripheral device slot 103a and 103b, the size of the peripheral devices should meet special specifications. Thus, when the peripheral devices are inserted in the peripheral device slots 103a and 103b, only the control panel at the front surface of the peripheral device is exposed at the host panel 110.

For example, to increase the function of the computer host 1, many manufacturers dispose display control devices to be inserted in the peripheral device slots 103a or 103b. FIG. 1B is a schematic diagram showing the display control device 11 inserted in the peripheral device slot 103. In FIG. 1B, the display control device 11 includes a control panel 110, and the control panel 110 may be exposed outside the host panel 10, and many function keys 1101 or knobs 1102 are disposed on the control panel 110 to directly control a built-in audio/video programs in the computer host 1 to make the computer host 1 a multimedia audio/video device and make the display area 1103 show the state of the audio/video program. For example, the user may use the functions such as adjusting the volume, playing the movie and fast playing at the control panel 110 directly, and a display area 1103 may show corresponding images according to the user's adjustment.

The control panel 110 included in the conventional display control device 11 and the host panel 10 of the computer are disposed on the same plane. Therefore, when the user puts the computer host 1 under a desk (or at any position lower than a common operating position where the user may operate the computer), he or she may feel it inconvenient to operate the function keys 1101 or the knobs 1102 on the control panel 110. In addition, the image shown on the display area 1103 also cannot be seen clearly. The user has to bend down to see the function keys 1101 or the knobs 1102 to set or adjust the functions. Thus, the user has more chances of wrongly contacting other function keys and making incorrect setting.

### SUMMARY OF THE INVENTION

The invention discloses a display control device and a computer host having the display control device. The display control device is disposed in a host case of the computer host, and it includes a body including a control circuit electronically connected to the computer host, a control panel electrically connected to the control circuit, and a pivot unit connected to the body and the control panel to change the surface of the control panel between a close state and an open state relative to the host case. In addition, the computer host is controlled via an operating unit on the control panel.

Another aspect of the invention provides a computer host including a host case and a display control device. The display control device further includes a body having a control circuit electronically connected to the computer host, a control panel electrically connected to the control circuit, and a pivot unit connected to the body and the control panel to change the surface of the control panel between a close state and an open state relative to the host case. In addition, the computer host is controlled via an operating unit on the control panel.

In the invention, a pivot unit is additionally disposed in the structure of the display control device to allow the control panel of the display control device to be changed between the close state and the open state according to the user's requirement. With the rotation of the pivot unit, the control panel is adjusted to a proper angle relative to the surface of the host case of the computer to allow the user to operate the display control device conveniently when the computer host is disposed at a lower position relative to the user.

### BRIEF DESCRIPTION OF THE DRAWINGS

These and other features, aspects and advantages of the present invention will become better understood with regard to the following description, appended claims, and accompanying drawings.

FIG. 1A is a schematic diagram showing a conventional host of a desktop computer;

FIG. 1B is a schematic diagram showing the display control device inserted in the peripheral device slot;

FIG. 2A and FIG. 2B are schematic diagrams showing the display control device in the invention developed to overcome the deficiency in the conventional devices;

FIG. 3A and FIG. 3B are side perspective diagrams showing the display control device in a first embodiment of the invention; and

FIG. 4A and FIG. 4B are side perspective diagrams showing the display control device in a second embodiment of the invention.

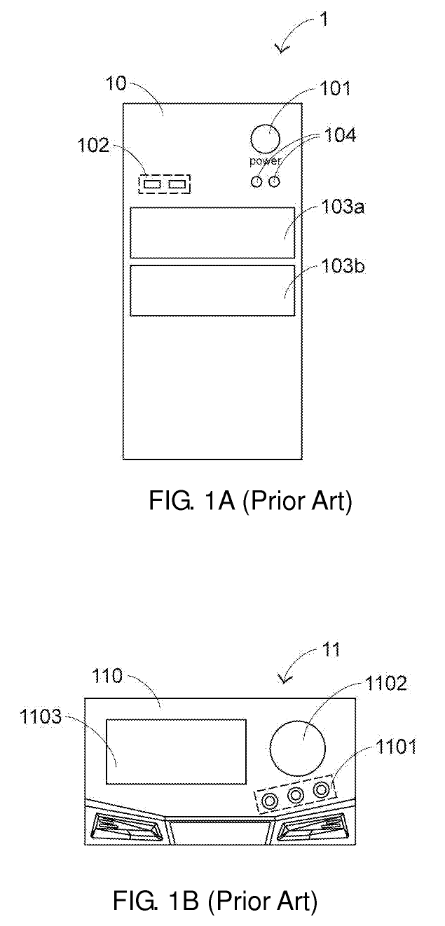

### DETAILED DESCRIPTION OF THE PREFERRED EMBODIMENT

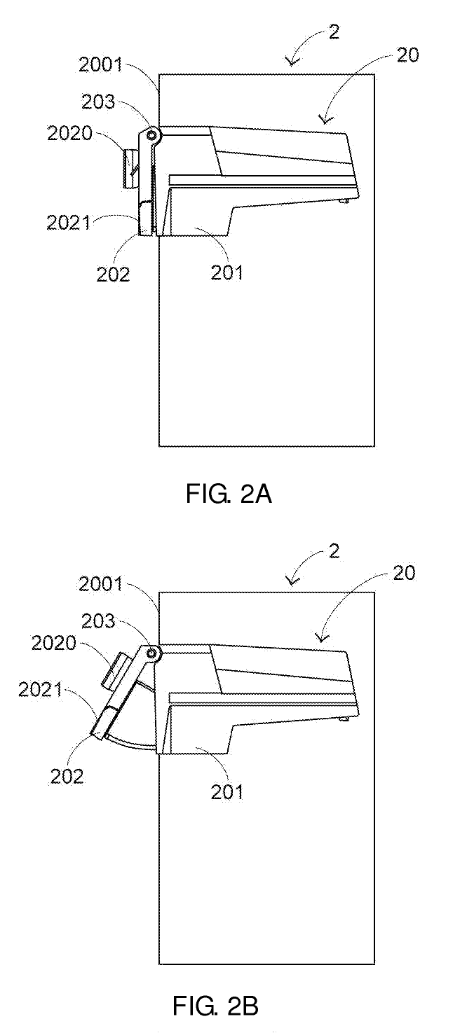

FIG. 2A and FIG. 2B are schematic diagrams showing a display control device in the invention developed to overcome the deficiency in the conventional device. The display control device 20 in the invention is inserted in a computer host 2. As shown in FIG. 2A and FIG. 2B, the display control device 20 is disposed inside the host case, and it mainly includes a body 201, a control panel 202 and a pivot unit 203. The body 201 of the display control device 20 includes a control circuit electronically connected to the computer host (not shown), and the control panel 202 is electrically connected to the control circuit included in the body 201. The control panel 202 controls an application (such as a multimedia audio/video application, not shown) executed in the computer host 2 via the operating unit 2020 disposed at a surface 2021. The main technique means of the invention is to add a pivot unit 203 to the display control device. The pivot unit 203 is pivotally connected to the body 201 and the control panel 202 of the display control device 20. When the user presses the control panel 202, the pivot unit 203 may rotate around an axis and thus change the angle between a surface 2021 of the control panel 202 and a surface 2001 of the host panel of the computer to change the control panel 202 between a close state and an open state.

FIG. 2A shows the control panel 202 in a close state. When the computer host 2 is disposed under the table or desk, to operate the operating unit (such as the knobs for adjusting the volume or the function keys for changing the functions) on the control panel 202 well, the user may press the control panel 202, and then the pivot unit 203 rotates to drive the control panel 202 to rotate to a proper angle relative to the surface 2001 of the host panel of the computer. At last, as shown in FIG. 2B, the control panel 202 is located at an open state for the user to operate conveniently. In addition, in both the close state and the open state, the operating unit 2020 on the control panel 202 and the control circuit in the body 201 may be electronically connected to each other.

Thus, the main technique means of the invention is to add a pivot unit 203 to the structure of the display control device 20 to change the control panel 202 of the display control device 20 between the close state and the open state according to the requirement of the user. With the rotation of the pivot unit 203, the surface 2021 of the control panel 202 is adjusted to an open state to form a proper angle relative to the surface 2001 of the host panel of the computer. Thus, the user may operate the display control device 20 conveniently when the computer host is disposed at the lower position relative to the user. The technique means in the invention is further illustrated hereinbelow.

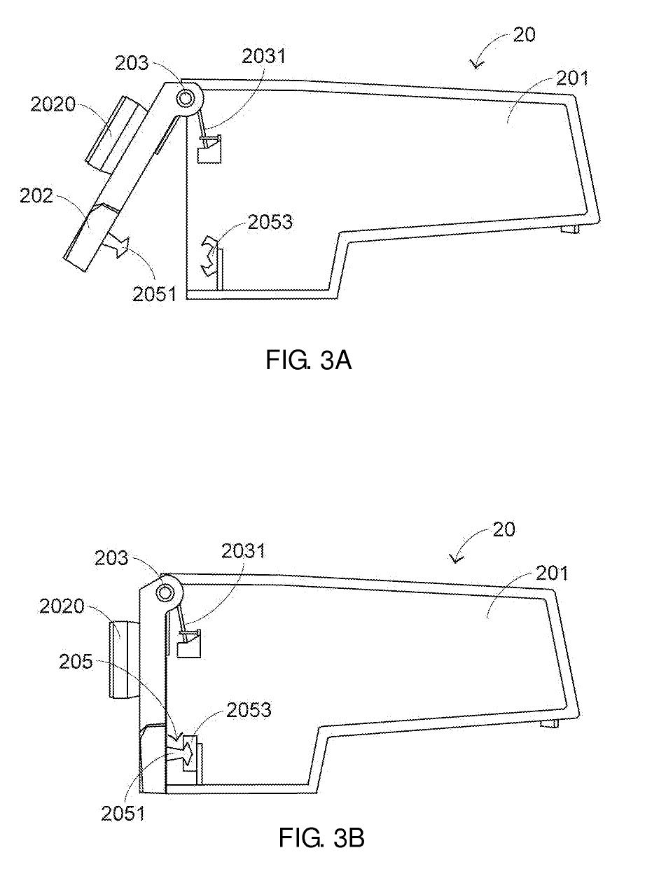

FIG. 3A and FIG. 3B are side perspective diagrams showing the display control device in a first embodiment of the invention. In FIG. 3A and FIG. 3B, the pivot unit 203 mainly includes an elastic element 2031. According to an embodiment of the invention, the elastic element 2031 is a torsional spring whose one end is fixed to the body 201 and the other end is fixed to the control panel 202. Thus, when the control panel 202 is changed from the close state to the open state, the resilience of the elastic element 2031 makes the control panel 202 rotate to the open state around the axis.

In addition, the display control device 20 further includes a door latch 205 whose a first latching element 2051 is fixed to the control panel 202 and a second latching element 2053 is fixed to the body 201. In the close state, when the user presses the control panel 202, the first latching element 2051 of the door latch 205 and the second latching element 2053 may be separated from each other, and as shown in FIG. 3A, by the resilience of the elastic element 2031, the control panel 202 may rotate to the open state around the axis.

In the open state, the user applies a force to push the control panel 202 to the close state. As shown in FIG. 3B, when the first latching element 2051 and the second latching element 2053 contact each other, the first latching element 2051 and the second latching element 2053 are locked to each other to form the close state.

In addition, to prevent the control panel 202 from rotating too fast during changing the close state to the open state, the pivot unit 203 may further include a damping element such as a gear element (not shown), and the function of the gear element is to slow the rotating speed of the control panel 202 rotating around the axis and to prevent the control panel 202 from projecting too fast to avoid damaging the whole structure. The damping element is only a selectable element, and it is not used to limit the scope of the invention.

In addition, in the open state in the first embodiment, the user may operate the operating unit 2020 on the control panel 202. For example, he or she may press the function keys or rotate the knobs to control the volume. In the operation, the user may apply a positive force on the control panel 202, and if the elastic element 2031 cannot bear the force applied by the user, the control panel 201 may shake.

The second embodiment further includes a fixing structure, and the main objective is to prevent the shake. That is, by the fixing structure disclosed in the second embodiment, when the user operates the operating unit 2020 in the open state, the control panel 201 may not shake.

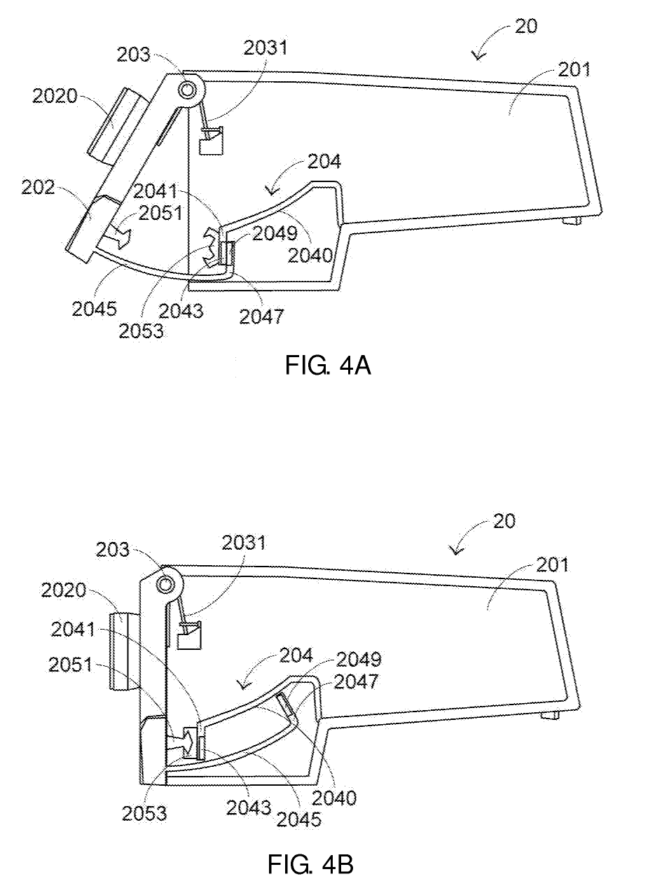

FIG. 4A and FIG. 4B are side perspective diagrams showing the display control device in a second embodiment of the invention. The actions of the elastic element 2031 and the door latch 205 are the same with those in the first embodiment, and they are not illustrated herein for a concise purpose.

According to the second embodiment of the invention, the display control device 20 further includes a fixing structure 204, and it is disposed on the body 201 of the display control device 20 and the control panel 202. The fixing structure 204 includes a first rail portion 2040, a first fixing portion 2041, a first magnet 2043, a second rail portion 2045, a second fixing portion 2047 and a second magnet 2049. The first rail portion 2040, the first fixing portion 2041 and the first magnet 2043 are located in the body 201 of the display control device 20, and a second rail portion 2045, a second fixing portion 2047 and a second magnet 2049 are fixed to the control panel 202. The first magnet 2043 and the second magnet 2049 may attract each other.

In addition, a first end of the first rail portion 2040 is fixed to the body 201, and a second end of the first rail portion 2040 has a first fixing portion 2041 where a first magnet 2043 is disposed. In addition, a first end of the second rail portion 2045 is fixed to the control panel 202, and a second end of the second rail portion 2045 has a second fixing portion 2047 where a second magnet 2049 is disposed.

As shown in FIG. 4A, in changing the close state to the open state, the second rail portion 2045, the second fixing portion 2047 and the second magnet 2049 may move relative to the first rail portion 2040, the first fixing portion 2041 and the first magnet 2043 via the resilience of the elastic element 2031 until the first magnet 2043 and the second magnet 2049 attract each other and are fixed to each other.

In addition, in changing the open state to the close state, the user has to apply a larger force to overcome an attracting force between the first magnet 2043 and the second magnet 2049. Afterwards, the second rail portion 2045, the second fixing portion 2047 and the second magnet 2049 may move relative to the first rail portion 2040, the first fixing portion 2041 and the first magnet 2043 via the pushing force applied by the user until the first latching element 2051 and the second latching element 2053 are locked to each other to form the close state, as shown in FIG. 4B. At that moment, the first magnet 2043 and the second magnet 2049 are separated from each other.

From the second embodiment, the fixing structure 204 may prevent the control panel 201 from shaking in the open state. That is, the positive force applied by the user when he or she adjusts the operating element 2020 is less than the attracting force between the first magnet 2043 and the second magnet 2049, and thus the control panel 201 may not shake.

A skilled person in the art also may design other fixing mechanisms having different structures according to the second embodiment of the invention to prevent the display control device 20 from shaking in the open state when the user operates the display control device 20. That is, the actual structure of the fixing structure is not limited.

In addition, the display control device 20 may control the computer host to execute the multimedia audio/video application, and it also may be used to control the operating frequency or the operating voltage of the computer host. For example, the function keys in the control panel may be used to select the operating voltage or the operating frequency of the computer host which needs to be adjusted, and the knobs may be used to adjust the increase or decrease of the operating voltage and the increase or decrease of the operating frequency. The display area may be used to show the current operating frequency and the current operating voltage for the user to refer to.

To sum up, in the display control device of the invention, a pivot unit is added, and the user presses the control panel to make the pivot unit rotate relative to an axis. Thus, the angle between the surface of the control panel and the surface of the host case of the computer is changed. That is, when the computer host used by the user is disposed at a lower position relative to the user (for example, it may be disposed under the table or the desk), the user may use the technique means in the invention to change the angle between the surface of the control panel and the surface of the host case of the computer to rotate the panel of the display control device to a proper angle to allow the user to operate easily. When the operation is finished, the control panel may be restored to the close state in which the control panel is parallel with the surface of the host case of the computer. Thus, the control panel is not protruded from the host case of the computer, and the volume of the computer host does not increase. Thus, the display control device in the invention may remove the deficiency of the conventional device, and the main objective of the invention is achieved. Persons having ordinary skill in the art may make various modifications and changes without departing from the scope and spirit of the invention.

What is claimed is:

1. A display control device disposed in a host case of a computer host, the display control device comprising:
a body including a control circuit electronically connected to the computer host;
a control panel electrically connected to the control circuit, wherein the computer host is controlled via an operating unit on the control panel; and
a pivot unit connected to the body and the control panel to change a surface of the control panel between a close state and an open state relative to the host case.

2. The display control device according to claim 1, further comprising a door latch whose first latching element is fixed to the control panel and second latching element is fixed to the body, wherein in the close state, when the control panel is pressed, the first latching element and the second latching element are separated to enter the open state, and in the close state, the first latching element and the second latching element are contact and locked each other.

3. The display control device according to claim 1, wherein the pivot unit comprises an elastic element.

4. The display control device according to claim 3, wherein the elastic element is a torsional spring, one end of the torsional spring is fixed to the body, and the other end of the torsional spring is fixed to the control panel.

5. The display control device according to claim 1, further comprising a fixing structure to prevent shaking of the control panel caused by using the operating unit in the open state, the fixing structure comprising:
a first rail portion whose first end is fixed to the body;
a first fixing portion disposed at a second end of the first rail portion;
a first magnet disposed on the first fixing portion;
a second rail portion whose first end is fixed to the control panel;
a second fixing portion disposed at a second end of the second rail portion; and
a second magnet disposed on the second fixing portion;
wherein during changing the close state to the open state, the second rail portion, the second fixing portion and the second magnet move to the first rail portion, the first fixing portion and the first magnet relatively until the first magnet and the second magnet attract each other and are fixed to each other.

6. The display control device according to claim 5, wherein during changing the open state to the close state, the second rail portion, the second fixing portion and the second magnet is moved to the first rail portion, the first fixing portion and the first magnet relatively, thus to separate the first magnet and the second magnet from each other.

7. The display control device according to claim 1, wherein the pivot unit comprises a damping element for reducing a rotating speed of the control panel with which the close state is changed to the open state;
wherein the damping element is a gear element.

8. The display control device according to claim 1, wherein the control panel comprises the operating unit for controlling an application executed in the computer host.

9. The display control device according to claim 1, wherein the control panel comprises the operating unit for controlling an operating voltage or an operating frequency of the computer host.

10. A computer host comprising:
a host case; and
a display control device including:
a body having a control circuit electronically connected to the computer host;
a control panel electrically connected to the control circuit, wherein the computer host is controlled via an operating unit on the control panel; and
a pivot unit pivotally connected to the body and the control panel to change a surface of the control panel between a close state and an open state relative to the surface of the host case.

11. The computer host according to claim 10, further comprising a door latch whose first latching element is fixed to the control panel and a second latching element is fixed to the body, wherein in the close state, when the control panel is pressed, the first latching element and the second latching element are separated from each other and enter the open state; and when in the close state, the first latching element and the second latching element are contact and locked to each other.

12. The computer host according to claim 10, wherein the pivot unit comprises an elastic element.

13. The computer host according to claim 12, wherein the elastic element is a torsional spring, one end of the torsional spring is fixed to the body, and another end of the torsional spring is fixed to the control panel.

14. The computer host according to claim 10, further comprising a fixing structure to prevent shake of the control panel caused by operating the operating unit in the open state, the fixing structure comprising:
a first rail portion whose first end is fixed to the body;
a first fixing portion disposed at a second end of the first rail portion;
a first magnet disposed on the first fixing portion;
a second rail portion whose first end is fixed to the control panel;
a second fixing portion disposed on a second end of the second rail portion; and
a second magnet disposed on the second fixing portion;
wherein during changing the close state to the open state, the second rail portion, the second fixing portion and the second magnet move relative to the first rail portion, the first fixing portion and the first magnet until the first magnet and the second magnet attract each other and are fixed to each other.

15. The computer host according to claim 14, wherein during changing the open state to the close state, the second rail portion, the second fixing portion and the second magnet move relative to the first rail portion, the first fixing portion and the first magnet to make the first magnet and the second magnet separated from each other.

16. The computer host according to claim 10, wherein the pivot unit comprises a damping element for reducing a rotating speed of the control panel with which the close state is changed to the open state;
wherein the damping element is a gear element.

17. The computer host according to claim 10, wherein the control panel comprises the operating unit for controlling an application executed in the computer host.

18. The computer host according to claim 10, wherein the control panel comprises the operating unit for controlling an operating voltage or an operating frequency of the computer host.
